(19) United States
(12) Patent Application Publication
(10) Pub. No.: US 2006/0064715 A1
(43) Pub. Date: Mar. 23, 2006

(54) System and method for ratings control of commercials

(76) Inventor: Thomas Poslinski, Elma, NY (US)

Correspondence Address: WAGNER, MURABITO & HAO LLP, Third Floor, Two North Market Street, San Jose, CA, 95113, US

(21) Appl. No.: 10/946,508

(22) Filed: Sep. 20, 2004

(51) Int. Cl. H04N 7/16; H04N 7/025; H04N 7/10

(52) U.S. Cl. 725/28; 725/34; 725/35; 725/25

(57) ABSTRACT

A method for blocking a broadcast of commercial content is disclosed. The method includes receiving the broadcast of the commercial content wherein the broadcast contains the rating of the commercial content. From this information the method determines if the rating of the commercial exceeds a preset maximum allowable limit and, if so, blocks the broadcast of the commercial content. The method may further include displaying a message indicating the blocked status of the commercial content.

### RELATED ART

Set-top boxes (STBs), some of which that enable other devices, such as video recorders, and others that enable a television set to receive and decode digital television broadcasts, are becoming increasingly popular. Digital television STBs can be used for satellite, cable, and terrestrial digital television services. Digital video recorders (DVRs) and personal video recorders (PVRs) are forms of STBs that may have these same capabilities.

Viewers of video broadcasts typically have the capability of locking out channels and/or setting rating limits for blocking programs that are being broadcast (e.g., for parental control), whether thru a STB or a V-chip in their television set. In other words, a parent may wish to prevent a child from watching certain channels, or programs that they find inappropriate or objectionable. A user may wish to block the viewing of all programs on a particular channel by locking out the channel, or, through ratings supplied along with the data stream by the service provider, a user is provided with the capability of filtering out undesirable programs by setting a limit on the ratings. Typically, any program exceeding the limit setting will not be broadcast unless the user overrides the limit setting with a password.

It is becoming evident that some commercial advertisements for products or services that are sponsoring programs rated for family viewing contain material that may be objectionable or inappropriate for some of the viewing audience. To date, commercial advertisements do not carry ratings, as do the programs that they sponsor. Therefore, parents and other members of the viewing public do not have the ability to control the viewing of inappropriate material that is broadcast in commercial advertisements being aired along with programs that are deemed appropriate (e.g., fall within the allowable limit settings) for the viewing audience.

### SUMMARY OF THE INVENTION

Embodiments of the present invention provide a method and system for controlling the viewing of commercial advertisements (commercials) based on a rating of the commercials' content. Rating control of commercials may be important to some users. Currently, commercials that are inappropriate for viewing by minors may be aired during programs that are allowed to be viewed by minors. There is no way, at the present time, of blocking these commercials in a set-top box, a TV set, a personal video recorder (PVR) or digital video recorder (DVR) system. Embodiments of the present invention allow ratings-based commercial blocking for both broadcast commercial content and playback of recorded commercial content.

Using a commercial data stream, a rating setting can be added for each transmitted commercial. The commercial data stream can be augmented to add rating information. When a commercial is aired live, or replayed during playback, the rating setting is used by the present invention to automatically block the displaying of the commercial. A user setup screen may be provided during setup that allows a user to set the rating setting for commercials, similar to that for setting locks and limit settings for programs. The setup screen may be displayed on the television screen. The rating settings may be a standard set of ratings, or they may be proprietary to the service provider. Once set, all commercials that match or exceed the preset rating setting are blocked by the controlling software, whether in a set-top box, a TV or a video recorder.

Commercial ratings, provided by the service provider, e.g., a cable company or satellite provider, may follow a rating system similar to that of broadcast programs. When a commercial is blocked during live broadcast, the user interface screen may go blank or a message may be displayed indicating the blocked status, or there may be a screen-saver display or any of a number of displays might replace the commercial broadcast in accordance with embodiments of the present invention. When a commercial is blocked during playback, the display may be the same as for live broadcast in one embodiment, e.g., blanked out, or the playback pointer may be moved to the end of the commercial and the commercial will be skipped.

During trick mode playback repositioning, in one embodiment, if the accelerated playback position is within a commercial's start and end time, and if playback data exists after the commercial end time, the next frame displayed for the next accelerated trick mode frame advance will be a frame following the end time of the commercial for a blanked out commercial. If no more playback data is available after the end time of the commercial and no record is in progress for the program, playback may stop. In one embodiment, if no more playback data is available after the commercial end time and the record is still in progress, the trick mode may be cancelled and the screen will go blank and, if applicable, an indication of the blocked status will be displayed.

More generally, a method for rating-based blocking a broadcast of commercial content is disclosed. The method includes receiving the broadcast of the commercial content wherein the broadcast has a signal associated therewith, containing the rating of the commercial content. From this information the method determines if the rating of the commercial exceeds a preset maximum allowable limit and, if so, blocks the local broadcast of the commercial content. The method may further include displaying a message indicating the blocked status of the commercial content.

In one embodiment, a digital interface device may receive the broadcast of the commercial in real-time in a video and an audio stream over a digital channel. The rating may be received in a data stream associated with the audio and video streams of the digital channel or could be a dedicated signal. The rating may be received in a repeating pattern during the broadcast of the commercial. In another embodiment, the rating may be received by auxiliary packets embedded throughout the video stream of the associated commercial broadcast. In another embodiment, the broadcast of the commercial may be received by an analog interface device wherein the broadcast is a series of frames of analog content. In one embodiment, the ratings can be received in vertical blanking intervals (VBI) embedded with the frames of analog content.

In another embodiment, the broadcast of the commercial may be in playback mode from a video recorder. In the playback mode, the digital interface device may blank out the commercial as in real-time broadcast (discussed above) or, in another embodiment, the playback pointer may be moved to the end of the commercial, thereby skipping the playback of the commercial.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of a television receiving system utilizing a media broadcast receiving system utilizing a media broadcast programming interface in accordance with an embodiment of the present invention.

FIG. 2 is a block diagram illustrating one embodiment of a consumer electronic network utilizing a media broadcast programming interface system in accordance with the present invention.

FIG. 3 is a block diagram illustrating another embodiment of a consumer electronic network utilizing a media broadcast programming interface system in accordance with the present invention.

FIG. 4 is a flowchart of a method, in accordance with one embodiment of the present invention, for ratings-based blocking a broadcast of a commercial that has a rating equal to or exceeding a preset limit.

FIG. 5A is a block diagram illustrating one embodiment of a screen of a display device having a commercial in blocked mode in accordance with the present invention.

FIG. 5B is a block diagram illustrating another embodiment of a screen of a display device having a commercial in blocked mode in accordance with the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

Some portions of the detailed descriptions which follow are presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic signals capable of being stored, transferred, combined, compared, and otherwise manipulated in a computer system. For reasons of convenience, and with reference to common usage, these signals are referred to as bits, values, elements, symbols, characters, terms, numbers, or the like with reference to the present invention.

It should be borne in mind, however, that all of these terms are to be interpreted as referencing physical manipulations and quantities and are merely convenient labels and are to be interpreted further in view of terms commonly used in the art. Unless specifically stated otherwise as apparent from the following discussions, it is understood that throughout discussions of the present invention, discussions utilizing terms such as “receiving” or “recognizing” or “utilizing” or “determining” or “playing” or “outputting” or “transmitting” or “blanking” or “displaying” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers or other such information storage, transmission, or display devices.

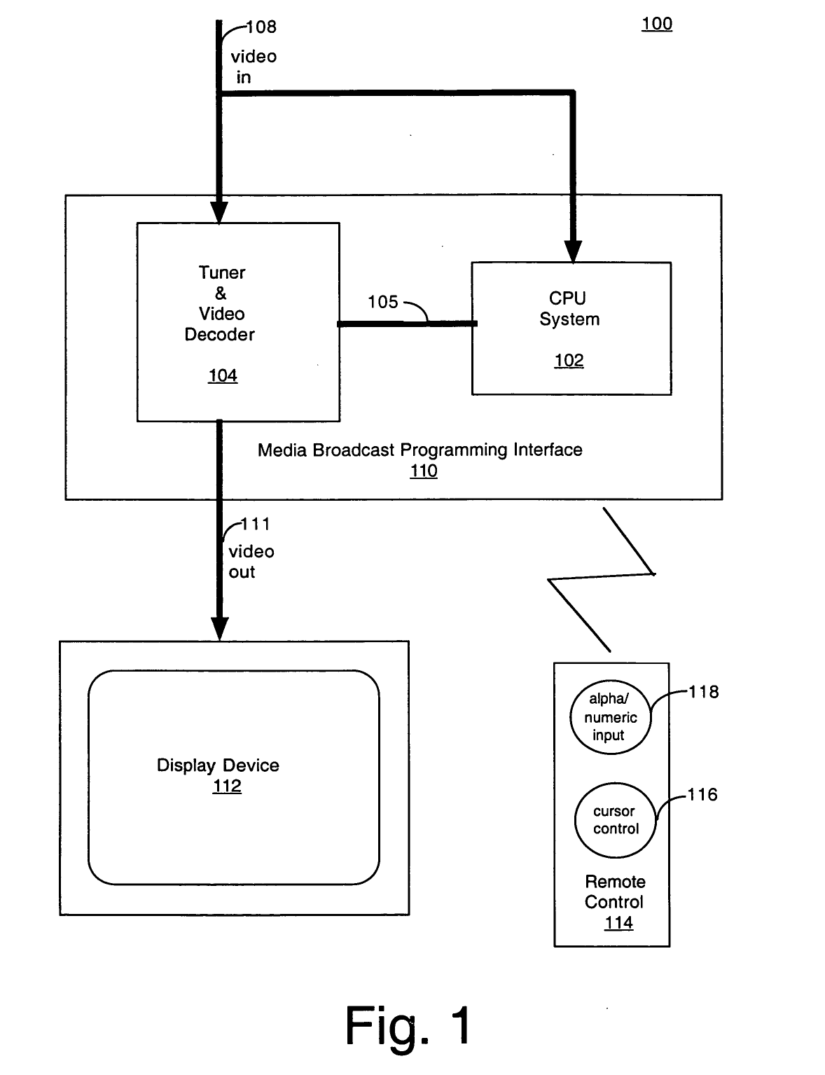

FIG. 1 is a block diagram of a media broadcast receiving system 100 utilizing a media broadcast programming interface 110 in accordance with an embodiment of the present invention. Within the following discussions of the present invention, certain processes and steps are discussed that are realized, in one embodiment, as a series of instructions (e.g., software program) that reside within computer readable memory units of media broadcast programming interface 110 and executed by processor system 102 of interface 110. When executed, the instructions cause media broadcast programming interface 110 to perform specific actions and exhibit specific behavior which is described in detail below. System 102 includes a processor coupled to a bus and memory units, e.g., RAM and ROM, coupled to the bus.

In general, media broadcast receiving system 100 of FIG. 1, as used by an embodiment of the present invention, comprises a media broadcast programming interface system 110 for providing a user a selectable interface with media broadcasts. Media broadcast programming interface 110 comprises an communication bus 105 for communicating information, a processor system 102 coupled with bus 105 for processing information and instructions. Processor system 102 may include a microprocessor or any other type of processor. The media broadcast programming interface 110 also includes a tuner and video decoder 104, controlled by CPU system 102 having circuitry for tuning and decoding video input signal 108 and generating video output signal 111.

In various embodiments, media broadcast programming interface 110 may be a set-top box for digital cable interface, for satellite interface, for terrestrial broadcast interface, or any type of media broadcast programming interface that provides an interface with which a user may select or program various functions for controlling viewing of media broadcasts.

Media broadcast receiving system 100 may include a display device 112, such as a television set or a computer monitor, which receives video output signal 111 for displaying video and/or graphics and may have an integrated speaker. It should be appreciated that display device 112 may be a cathode ray tube (CRT), flat panel liquid crystal display (LED), field emission display (FED), plasma display or other display device suitable for displaying video and/or graphic images. Furthermore, the media broadcast receiving system 100 can optionally include a control device 114 including alphanumeric and function keys 118 and a cursor control or cursor directing device 116 for communicating user input information and command selections to media broadcast interface 110. Control device 114 may be remote. Control device 114 can be implemented using a number of well known methods such as a remote control device (e.g., a universal remote control device having a number of buttons, dials, etc.) with an infra-red signal communication capability or it may be a wired input panel on the media broadcast interface system and coupled to the video decoder 104 circuitry. The present invention is also well suited to directing a cursor by other means such as, for example, voice commands. In addition, the cursor control 116 can also be a mouse, a track ball, a track pad, an optical tracking device, a touch screen, etc. Alternatively, it is appreciated that a cursor can be directed and/or activated via input from alphanumeric input device 118 using special keys and key sequence commands.

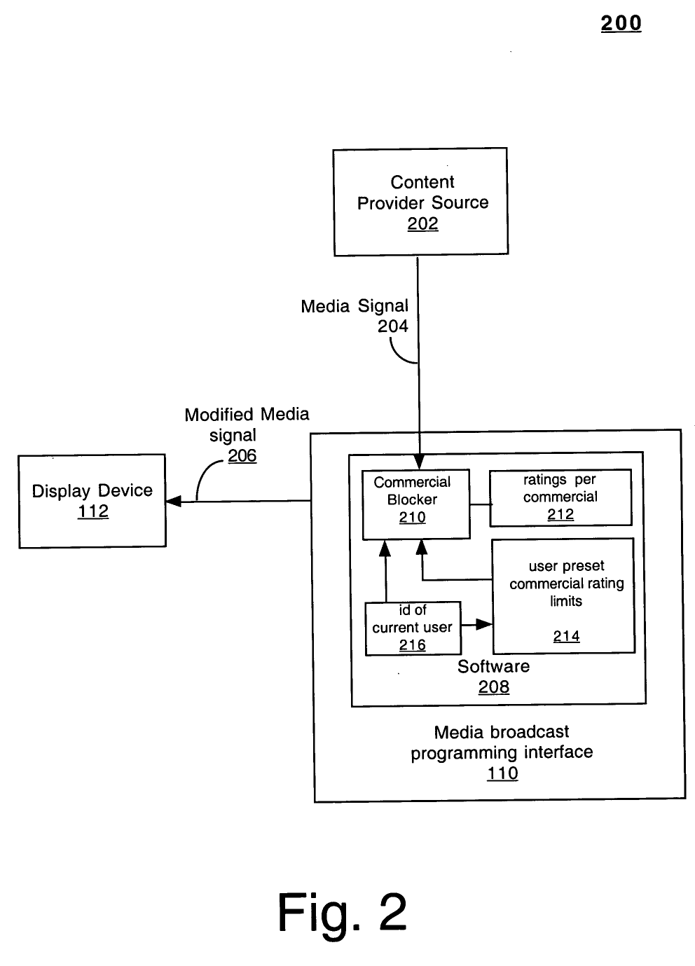

Referring now to FIG. 2, a block diagram illustrates one embodiment of a consumer electronic network 200 utilizing a media broadcast programming interface 110, in accordance with the present invention. According to the present embodiment, media broadcast programming interface 110 may be a set-top box. Media broadcast programming interface 110 may be a digital cable set-top box, a satellite set-top box, a terrestrial set-top box or any type of device that provides a programming interface between a broadcast media stream 204 and a display device 112. Source 202 may be a live, real-time broadcast or may be a source of recorded content.

In one embodiment of the present invention, when a user of media broadcast programming interface 110 sets ratings limits for commercials to be blocked, software 208 reads rating information from media signal 204 in real-time, determines the ratings of commercials and compares them to ratings limit settings and checks for blocked commercial content.

Software 208 comprises a commercial blocker 210 that has access to the ratings of programs, as shown in block 212 of software 208, that are broadcast over media stream 204. At block 214 of software 208, a user may set and/or reset limits to block commercial content via an input control device (e.g., remote control device 114 of FIG. 1) after identifying himself by a user id, as indicated in block 216. Program blocker 210 then compares the ratings of the commercials (block 212) being broadcast to the user's ratings limit settings (214) and checks for blocked commercial content. If a commercial content rating exceeds a preset maximum rating limit, or, in another embodiment, if the preset limit equals or exceeds the preset rating limit, commercial blocker 210 modifies the display and sends modified signal 206 to display device 112 to indicate the blocked status of any blocked commercials. If media signal 204 is received via a digital channel, the ratings may be received in a digital stream, or they may be received in auxiliary packets in a video stream. In another embodiment, the rating information may be embedded in vertical blanking intervals (VBIs) for either digital or analog signals, much the same as closed captioning is embedded in VBIs. Traditionally, VBI is used to carry closed captioning and extended data services (XDS) over Line 21. However, recently, additional VBI lines are being used to carry additional information.

The rating information can be sent in repeating patterns throughout the broadcast of each commercial content. This provides rating information that is readily available for comparison to the pre-set limit so that commercial blocking can be provided for a user tuning in the middle of a commercial, or a user that is “channel surfing” during the broadcasting of a commercial. Once a signal is blocked, display device 112 receives modified signal 206, having the blocked signal, and displays either a blank screen or a screen that displays an indication of the blocked status of the commercial.

Still referring to FIG. 2, according to one embodiment, media broadcast programming interface 100 is a video recorder. In this instance, media broadcast programming interface may record (cache) media signal 204 for later playback. When a commercial is blocked during playback, the display at display device 112 may be the same as for live broadcast, or a playback pointer may be moved to the end of the commercial and the commercial will be skipped.

During trick mode playback repositioning, if the accelerated playback position is within a commercial's start and end time, and if playback data exists after the commercial end time, the next frame displayed for the next accelerated trick mode frame advance will be a frame following the end time of the commercial. If no more playback data is available after the end time of the commercial and no record is in progress for the program, playback will stop. If no more playback data is available after the commercial end time and the record is still in progress, the trick mode will be cancelled and the screen will go blank and, if applicable, an indication of the blocked status will be displayed.

Network 200 includes a content provider source 202 (e.g., television broadcast company, the Internet, television cable company, and the like) coupled to media broadcast programming interface 110, which is coupled to display device 112. As such, the media broadcast programming interface 110 is coupled to receive a media stream 204 which is output by content provider source 202. Furthermore, display device 112 is coupled to receive media stream 204 and EPG Stream 206, which has been modified to provide indication of blocked broadcasts, both of which are output by media broadcast programming interface 110. As discussed above, source 202 may also be a playback source of recorded content.

It is appreciated that content provider source 202 and media broadcast programming interface 110 of the present embodiment are well suited to be coupled in a wide variety of implementations. For example, content provider source 202 and media broadcast programming interface 110 may be coupled via coaxial cable, copper wire, the Internet, fiber optics, wireless communication, and the like. Moreover, the media broadcast programming interface 110 and display device 112 of the present embodiment are also well suited to be coupled in a wide variety of implementations. For instance, media broadcast programming interface 110 and display device 112 may be coupled via fiber optics, wireless communication, coaxial cable, the Internet, copper wire, and the like.

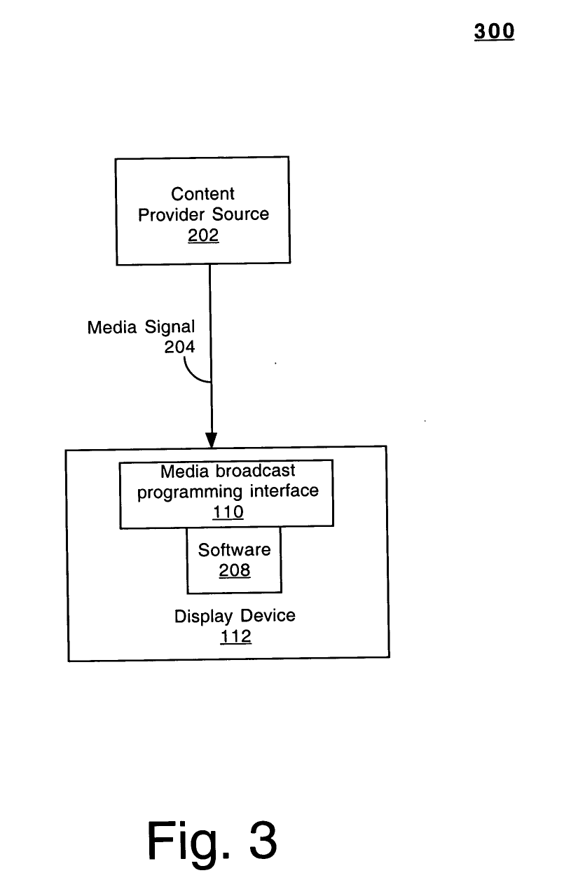

FIG. 3 is a block diagram illustrating another embodiment of a consumer electronic network 300 utilizing a media broadcast programming interface 110 in accordance with the present invention. According to the present embodiment, media broadcast programming interface 110 may reside within display device 112 and provide a programming interface between broadcast media stream 204 and the video display. In one embodiment of the present invention is that when a user sets limits for commercials to be blocked (e.g., via a V-chip interface menu), software 208 reads media stream 204 in real-time, determines the ratings of commercials and compares them to limit settings and checks for blocked content at time of rendering. According to one embodiment, media stream 204 may receive commercial ratings through the use of the video-blanking interval (VBI). Traditionally, VBI is used to carry closed captioning and extended data services (XDS) over Line 21. However, ecently additional VBI lines are being used to carry EPG data, which may include currently shown commercial ratings data.

Once the blocked information is identified, software 208 then modifies media signal 204 to indicate the blocked status of any blocked commercial content and renders it to the video display of display device 112. Display device 112 then may either show a blank screen, or may indicate by any of a number of displays that commercial content is being blocked.

Network 300 includes a content provider source 202 (e.g., VBI broadcasts, network television broadcast company, the Internet, television cable company, and the like) coupled to media broadcast programming interface 110, which is coupled to and resides, along with software 208, within and as an integral part of display device 112. Source 202 could also be a source of recorded media. As such, the media broadcast programming interface 110 is coupled to receive media stream 204 that is output by content provider source 202. Furthermore, display device 112 is configured to display data from media stream 204 that has been modified by software 208 to provide indication of blocked commercial broadcasts. It is appreciated that content provider source 202 and media broadcast programming interface 110, contained within and coupled to display device 112 of the present embodiment, are well suited to be coupled in a wide variety of implementations. For example, content provider source 202 and media broadcast programming interface 110 may be coupled via coaxial cable, copper wire, the Internet, fiber optics, wireless communication, and the like.

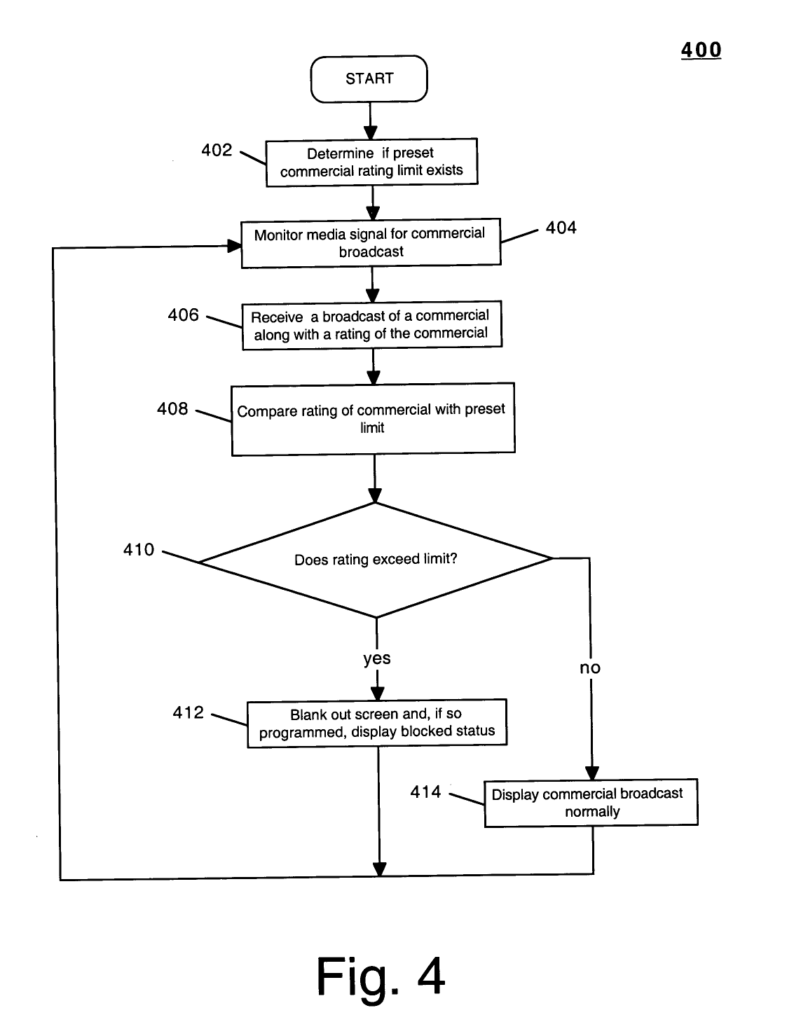

FIG. 4 is a flowchart of a method 400, in accordance with one embodiment of the present invention, for blocking the broadcast of a commercial that has a rating equal to or exceeding a preset limit. Although specific steps are disclosed herein describing the operations of method 400, such steps are exemplary. That is, embodiments of the present invention are well suited to performing various other steps or variations of the steps recited in the flowchart herein.

At step 402 of FIG. 4, according to one embodiment, media broadcast programming interface 100 determines if a preset commercial rating limit exists. These preset rating limits are set by an identified consumer to block the viewing of undesirable commercials. The consumer may disable the settings at any time by providing a valid identification and/or password. According to one embodiment, when the consumer electronic network contains a separate set-top box or video recorder that houses media broadcast programming interface 100 (e.g., network 200 of FIG. 2), the user may set the commercial rating limit at the set-top box. In another embodiment, the commercial rating limit settings may be set in a V-chip residing in the display device. In the embodiment in which the consumer electronic network houses media broadcast programming interface within display device (e.g., network 300 of FIG. 3), the commercial rating limit settings reside within the display device.

At step 402, a user may define a ratings limit for the local set top box. This ratings limit, when actuated, will be in force until a password deactivates the limit. Alternatively, a separate ratings limit may be defined for different potential viewers of the system. Upon logging in with a user name or identity, the system would automatically select the appropriate ratings limit.

At step 404 of FIG. 4, media signal 204 is received and monitored for the broadcast of commercial content by media broadcast programming interface (e.g., media broadcast programming interface 100 of FIG. 1), in accordance with one embodiment of the present invention. The media signal, according to the present embodiment, may contain a rating for each commercial being broadcast.

At step 406 of method 400, the media broadcast programming interface receives the broadcast of commercial content along with a rating and the broadcast channel for each commercial content that is broadcast, according to an embodiment of the present invention. This information may be transmitted in a VBI according to one embodiment. In another embodiment it may be transmitted in a digital data stream or, in yet another embodiment, as an auxiliary packet embedded in a digital video stream. There are numerous ways in which the rating information may be transmitted, any of which may apply to the present embodiments.

The rating information can be transmitted in repeating patterns throughout the broadcast of each commercial content. This provides rating information that is readily available for comparison to the pre-set limit so that commercial blocking can be provided for a user tuning in the middle of a commercial, or a user that is “channel surfing” during the broadcasting of a commercial.

At steps 408, Media broadcast programming interface then, according to one embodiment, compares the commercial content rating to the currently programmed ratings limit settings.

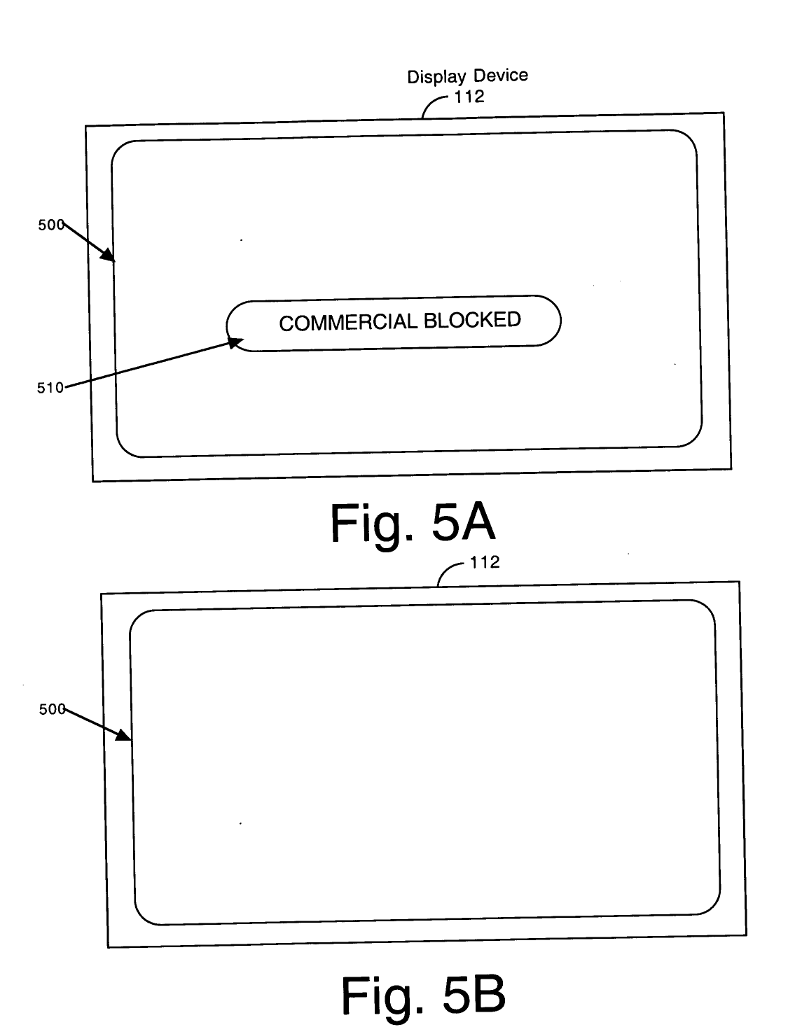

At step 410, according to an embodiment of the present invention, if the commercial content is determined to have a rating that meets or exceeds the preset limit, method 400 proceeds to step 412 following step 408. When a commercial is blocked, the display device receives a modified signal, having the blocked commercial broadcast, and displays either a blank screen or a screen that displays an indication of the blocked status of the commercial (see FIGS. 5A and 5B below).

If the rating of the commercial content does not equal or exceed the preset limit, method 400 proceeds to step 414. At step 414, according to one embodiment, if it is determined that the commercial content is permissible, the commercial content is broadcast, and method 400 continues.

FIG. 5A is a block diagram illustrating one embodiment of a screen of a display device having a commercial in blocked mode in accordance with the present invention. When a user has selected limit settings in order to block the selection of undesirable commercial content, the blocked status can be indicated on display device 112. For an example, according to one embodiment of the present invention, if a commercial being broadcast is determined to have a rating that exceeds the rating limits set by the user, the blocked status may be shown on display screen 500 by a message 510 stating “commercial blocked,” or a similar message. The message 510 may be contained in a window as shown, or, in another embodiment, it may be a banner that scrolls across the screen. In yet another embodiment, message 510 may flash. According to one embodiment, the message 510 may be in a distinct color, e.g., magenta or green. In another embodiment, message 510 may be black. In one embodiment the screen in the background may be displayed in a color that is different from the color of the message 510.

FIG. 5B is a block diagram illustrating another embodiment of a screen 500 of a display device 112 having a commercial content in blocked mode, in accordance with the present invention. Screen 500 may be blanked out during the duration of the broadcast of a blocked-out commercial. In another embodiment, the screen may have no message, but may change colors during a blocked commercial broadcast. In yet another embodiment, the screen may blink on and off when in a blocked content mode.

The foregoing descriptions of specific embodiments have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for blocking a broadcast of commercial content, said method comprising:
accessing a signal comprising commercial content, wherein said signal is associated with rating information for said commercial content;
determining if rating information associated with a particular commercial content exceeds a predetermined maximum allowable limit; and
in an affirmative response to said determining, blocking rendering of said particular commercial content.

2. The method as recited in claim 1 further comprising displaying a message indicating said blocking rendering.

3. The method as recited in claim 1 wherein said signal is a digital channel.

4. The method as recited in claim 3 wherein said rating information is received in a digital data stream associated with said digital channel.

5. The method as recited in claim 3 wherein said rating information is received in auxiliary packets embedded throughout a video stream of said digital channel.

6. The method as recited in claim 1 wherein said rating information is received in a repeating pattern during said accessing of said commercial content.

7. The method as recited in claim 1 wherein said rating information is received in vertical blanking intervals embedded within frames of analog content.

8. The method as recited in claim 1 wherein said signal and said rating information is supplied by a video recording device during a playback mode.

9. The method as recited in claim 8 wherein said blocking comprises moving a playback pointer to the end of said particular commercial content for skipping said particular commercial content.

10. The method as recited in claim 1 wherein said determining is performed by a processor residing in a set-top box.

11. The method as recited in claim 1 wherein said determining is performed by a processor residing in a display device.

12. A method of blocking the viewing of select commercial content on a display screen, said method comprising:
accessing descriptive information regarding commercial content being received;
based on said descriptive information, determining select commercial content that is to be blocked from display on said display screen;
blocking said select commercial content that is to be blocked using a blocked visual format; and
displaying other commercial content that is not to be blocked in a non-blocked visual format.

13. The method as described in claim 12 wherein said descriptive information comprises rating information for said commercial content being received and wherein said determining comprises determining said select commercial content that is to be blocked based on rating information that exceeds a predetermined maximum allowable rating.

14. The method as described in claim 12 wherein said commercial content and said descriptive information are received over a broadcast.

15. The method as described in claim 14 wherein said descriptive information is received over a digital data stream associated with a digital channel.

16. The method as described in claim 14 wherein said descriptive information is received in auxiliary packets embedded throughout a video stream of a digital channel.

17. The method as described in claim 14 wherein said descriptive information is received periodically during said broadcast of said commercial content.

18. The method as described in claim 14 wherein said descriptive information is received in vertical blanking intervals embedded within said broadcast.

19. The method as described in claim 12 wherein said commercial content and said descriptive information are supplied by a video recording device during a playback mode.

20. The method as described in claim 19 wherein said blocking select commercial content comprises moving a playback pointer to the end of said select commercial content for skipping said select commercial content.

21. An electronic device comprising a processor coupled to a bus and a memory coupled to said bus wherein said memory is programmed to implement a method of preventing the viewing of select commercial content on a display screen, said method comprising:
accessing rating information regarding and in conjunction with commercial content being received;
based on said rating information, determining select commercial content that is to be blocked from display on said display screen;
blocking display of said select commercial content that is to be blocked using a blocked visual format; and
displaying other commercial content that is not to be blocked in a non-blocked visual format.

22. The electronic device as described in claim 21 wherein said determining comprises determining said select commercial content that is to be blocked based on rating information that exceeds a predetermined maximum allowable rating.

23. The electronic device as described in claim 21 wherein said commercial content and said rating information are received in real time by a digital broadcast.

24. The electronic device as described in claim 21 wherein said rating information is received periodically during said broadcast of said commercial content.

25. The electronic device as described in claim 21 wherein said commercial content and said rating information are supplied by a video recording device during a playback mode.

26. The electronic device as described in claim 25 wherein said blocking display of said select commercial content that is to be blocked comprises moving a playback pointer to the end of said select commercial content for skipping said select commercial content.
